(19) United States
(12) Patent Application Publication
(10) Pub. No.: US 2014/0307065 A1
(43) Pub. Date: Oct. 16, 2014

(54) STEREOSCOPIC IMAGE DISPLAY METHOD, STEREOSCOPIC IMAGE DISPLAY DEVICE, AND EYE GLASSES FOR STEREOSCOPIC IMAGE VIEWING

(71) Applicant: Akihiro Okano, Kawasaki-shi (JP)

(72) Inventor: Akihiro Okano, Kawasaki-shi (JP)

(73) Assignees: PIONEER SOLUTIONS CORPORATION, Kawasaki-shi (JP); PIONEER CORPORATION, Kawasaki-shi (JP)

(21) Appl. No.: 14/352,886

(22) PCT Filed: Oct. 20, 2011
(86) PCT No.: PCT/JP2011/074129

§ 371 Date: Jun. 26, 2014

(51) Int. Cl. H04N 13/04

(52) U.S. Cl. CPC H04N 13/0497
USPC 348/51

(57) ABSTRACT

A stereoscopic display comprises: a first light-emitting unit that emits a first infrared ray in a first direction directed outward from a display surface; a second light-emitting unit that emits a second infrared ray in a second direction opposite the first direction; a display controller that alternately displays a right eye image and a left-eye image for a front-side user at a side of display surface in the first direction; and a vision controller that controls a vision of the user so that, in accordance with a control signal transmitted through the infrared ray, the image is visible

### TECHNICAL FIELD

The present invention relates to a stereoscopic display method, a stereoscopic display and stereoscopic glasses.

### BACKGROUND ART

Typically known stereoscopic display method includes a so-called frame sequential display method in which a right-eye image and a left-eye image with binocular parallax are used to see a stereoscopic image (3D [3-Dimension] image) to a user (see, for instance, Patent Literature 1).

In the frame sequential method, a display alternately displays a right-eye image and a left-eye image, and stereoscopic glasses alternately open/close a right-eye shutter and a left-eye shutter in accordance with a control signal. The above operations of the display and the glasses allow a user to see the right-eye image with the right eye and the left-eye image with the left eye, where the binocular parallax is perceived by the brain into a form of a three-dimensional image, whereby the user can see a stereoscopic image.

### CITATION LIST

### Patent Literature(s)

Patent Literature 1 JP-A-2011-191347

### SUMMARY OF THE INVENTION

### Problem(s) to be Solved by the Invention

In recent years, a table-type display device having a display surface facing upward has come to be widely used. It is desirable to employ the frame sequential method in the table-type display device to allow a user to see a stereoscopic image.

However, when a stereoscopic image is to be displayed on the display device by the frame sequential method to be viewed by two users standing at opposite points across a display surface of the display device, the following problem occurs.

Specifically, one of the users sees the right-eye image with the right eye and sees the left-eye image with the left eye. Accordingly, the stereoscopic effect of the stereoscopic image (e.g. depth and texture) recognized by the one of the users coincides with the stereoscopic effect to be expressed by the stereoscopic image. In contrast, the other one of the users sees the right-eye image with the left eye and sees the right-eye image with the left eye. Accordingly, the stereoscopic effect recognized by the other one of the users is reverse to the stereoscopic effect intended to be expressed by the stereoscopic image.

An object of the invention is to provide a stereoscopic display method, a stereoscopic display, and stereoscopic glasses that allow users seeing a display surface from different points to appropriately see a stereoscopic image.

### Means for Solving the Problem(s)

A method for displaying a stereoscopic image according to an aspect of the invention is for displaying the stereoscopic image to a user wearing stereoscopic glasses comprising a right-eye shutter facing a right eye of the user, a left-eye shutter facing a left eye of the user and a shutter controller that is configured to control the right-eye shutter and the left-eye shutter based on a control signal, the stereoscopic image being seen by showing the user a right-eye image and a left-eye image with binocular parallax, the method including; using a display device comprising: a display with a display surface facing upward; a first light-emitting unit that emits a first infrared ray directional in a first direction toward an outside of the display surface in a plan view of the display surface; and a second light-emitting unit that emits a second infrared ray directional in a second direction opposite to the first direction in the plan view of the display surface; alternately displaying on the display surface the right-eye image and the left-eye image for a front-side user positioned at a side of the display surface in the first direction; and controlling a vision of the user so that: in accordance with a first control signal transmitted through the first infrared ray, when the user is positioned at a side of the display surface in the first direction, the right-eye image for the front-side user is visible to the right eye of the user at the side in the first direction while the left-eye image for the front-side user is visible to the left eye of the user at the side in the first direction and; in accordance with a second control signal transmitted through the second infrared ray, when the user is positioned at a side in the second direction of the display surface, the right-eye image for the front-side user is visible to the left eye of the user positioned at the side in the second direction while the left-eye image for the front-side user is visible to the right eye of the user positioned at the side in the second direction.

A stereoscopic display according to another aspect of the invention allows visualization of a stereoscopic image to a user wearing stereoscopic glasses comprising a right-eye shutter facing a right eye of the user, a left-eye shutter facing a left eye of the user and a shutter controller that controls the right-eye shutter and the left-eye shutter based on a control signal, the stereoscopic image being seen by showing the user a right-eye image and a left-eye image with binocular parallax, the stereoscopic display including: a display with a display surface facing upward; a first light-emitting unit that emits a first infrared ray directional in a first direction toward an outside of the display surface in a plan view of the display surface; a second light-emitting unit that emits a second infrared ray directional in a second direction opposite to the first direction in the plan view of the display surface; a display controller that alternately displays on the display surface the right-eye image and the left-eye image for a front-side user positioned at a side of the display surface in the first direction; and a vision controller that controls a vision of the user so that: in accordance with a first control signal transmitted through the first infrared ray, when the user is positioned at the side of the display surface in the first direction, the right-eye image for the front-side user is visible to a right eye of the user at the side in the first direction while the left-eye image for the front-side user is visible to a left eye of the user at the side in the first direction; and in accordance with a second control signal transmitted through the second infrared ray, when the user is positioned at a side of the display surface in the second direction, the right-eye image for the front-side user is visible to the left eye of the user positioned at the side in the second direction while the left-eye image for the front-side user is visible to the right eye of the user positioned at the side in the second direction.

Stereoscopic glasses according to still another aspect of the invention is used for seeing a right-eye image and a left-eye image with binocular parallax alternately displayed by a stereoscopic display to allow a user to see a stereoscopic image, the stereoscopic glasses including: a right-eye shutter that is configured to face a right eye of the user; a left-eye shutter that is configured to face a left eye of the user; and a shutter controller that is configured to receive a control signal to control the right-eye shutter and the left-eye shutter in accordance with the control signal, in which the shutter controller is configured to: close only the right-eye shutter at a first predetermined timing upon receipt of the control signal for closing only the right-eye shutter at the first predetermined timing; close only the left-eye shutter at a second predetermined timing upon receipt of the control signal for closing only the left-eye shutter at the second predetermined timing; and when both the control signal for closing only the right-eye shutter and the control signal for closing only the left-eye shutter are not received, open both the right-eye shutter and the left-eye shutter.

### BRIEF DESCRIPTION OF DRAWING(S)

FIG. 1 is a perspective view showing a stereoscopic display system according to a first exemplary embodiment of the invention.

FIG. 2 is a block diagram schematically showing an arrangement of the stereoscopic display system.

FIG. 3 is a timing chart showing an operation of a stereoscopic display of the stereoscopic display system.

FIG. 4 is a timing chart showing an operation of stereoscopic glasses of the stereoscopic display system.

FIG. 5 is a perspective view showing a stereoscopic display system according to a second exemplary embodiment of the invention.

FIG. 6 is a block diagram schematically showing an arrangement of the stereoscopic display system.

FIG. 7 is a timing chart showing operations of a stereoscopic display and stereoscopic glasses of the stereoscopic display system.

FIG. 8 is a flow chart showing an operation of stereoscopic glasses according to a modification of the invention.

### DESCRIPTION OF EMBODIMENT(S)

### First Exemplary Embodiment

A first exemplary embodiment of the invention will be described below with reference to the attached drawings.

### Arrangement of Stereoscopic System

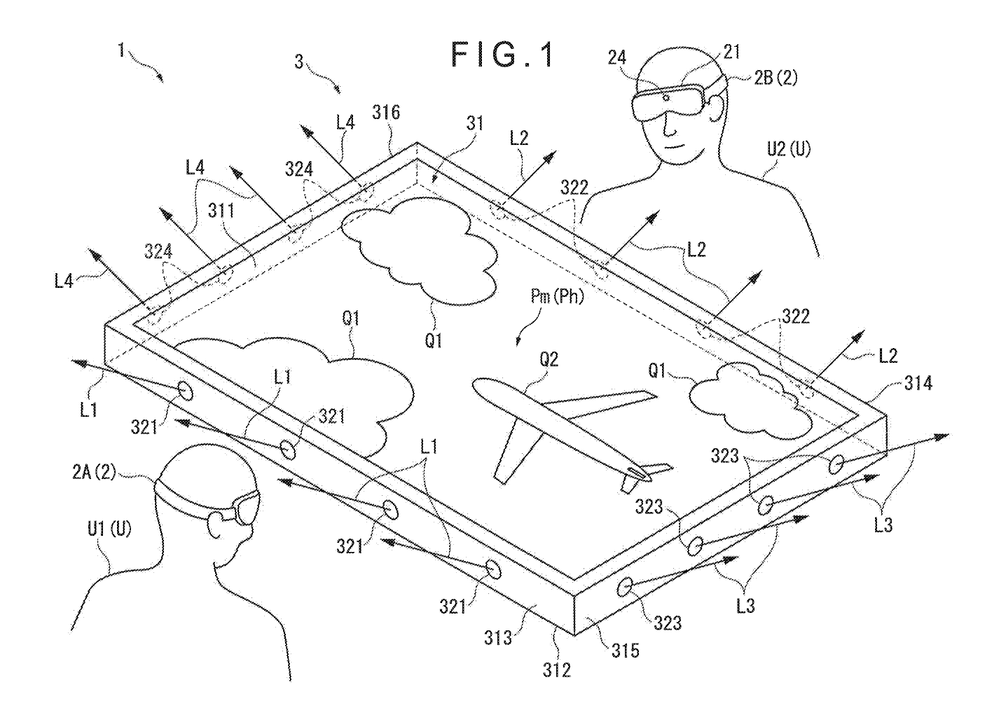

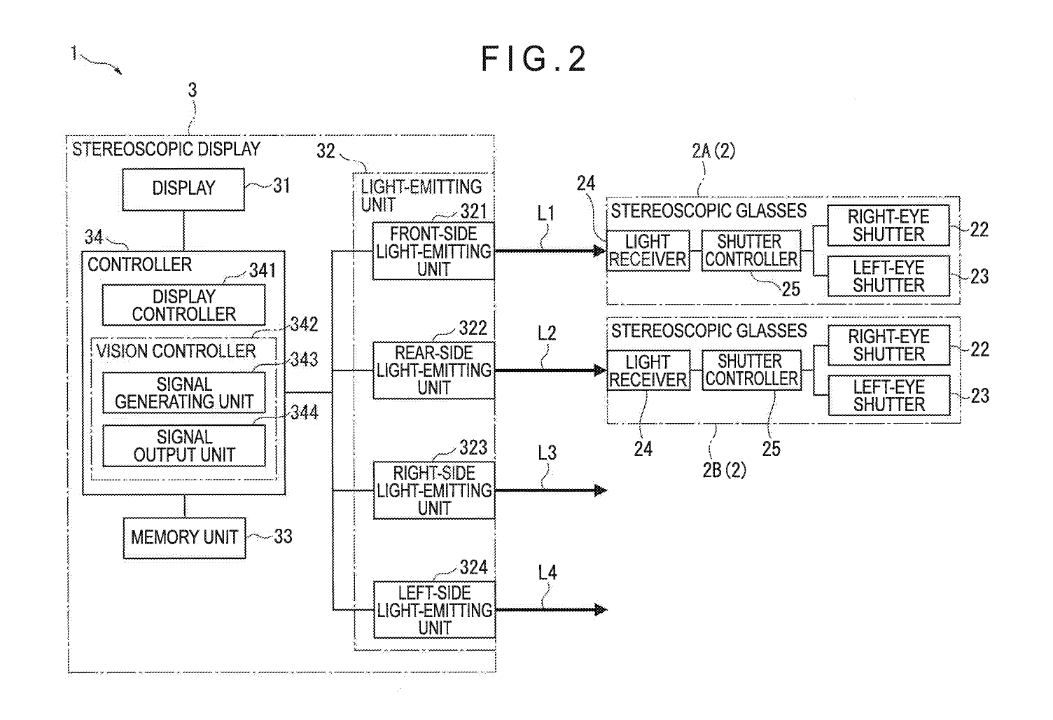

In FIG. 1, a stereoscopic system 1 allows a user U to see a stereoscopic image with the use of a right-eye image Pm and a left-eye image Ph with binocular parallax. As shown in FIGS. 1 and 2, the stereoscopic system 1 includes stereoscopic glasses 2 to be worn by the user U, and a stereoscopic display 3 on which the right-eye image Pm and the left-eye image Ph are displayed.

The stereoscopic glasses 2 include an attachment portion 21 to be mounted on a head of the user U. The attachment portion 21 includes a right-eye shutter 22 adapted to face the right eye of the user U, a left-eye shutter 23 adapted to face the left eye of the user U, a light receiver 24 and a shutter controller 25.

The light receiver 24 is disposed, for instance, at a front side of the attachment portion 21 and receives under the control of the shutter controller 25 a front-side infrared ray L1 (later-described first infrared ray), a rear-side infrared ray L2 (later-described second infrared ray), a right-side infrared ray L3 (later-described third infrared ray) and a left-side infrared ray L4 (fourth infrared ray) emitted by the stereoscopic display 3.

The shutter controller 25 controls opening/closing of the right-eye shutter 22 and the left-eye shutter 23 based on a control signal outputted through the front-side infrared ray L1, the rear-side infrared ray L2, the right-side infrared ray L3 and the left-side infrared ray L4.

The stereoscopic display 3 is a table-type display device having a display surface 311 facing upward. The stereoscopic display 3 includes a display 31, a light-emitting unit 32, a memory unit 33 and a controller 34.

The display 31 includes the display surface 311 having a rectangular shape. The display 31 is held in a rectangular frame 312 with the display surface 311 facing upward. The frame 312 includes a front portion 313 that defines one of long sides of the rectangular shape, a rear portion 314 that defines the other one of the long sides of the rectangular shape, a right portion 315 that defines one of short sides of the rectangular shape and a left portion 316 that defines the other one of short sides of the rectangular shape.

The light-emitting unit 32 includes a front-side light-emitting unit 321 in a form of four first light-emitting units provided at the front portion 313, a rear-side light-emitting unit 322 in a form of four second light-emitting units provided at the rear portion 314, a right-side light-emitting unit 323 in a form of four third light-emitting units provided at the right portion 315 and a left-side light-emitting unit 324 in a form of four third light-emitting units provided the left portion 316. It should be noted in FIG. 2 that one of the front-side light-emitting units 321, one of the rear-side light-emitting units 322, one of the right-side light-emitting units 323 and one of the left-side light-emitting units 324 are each shown in a form of a single component.

The front-side light-emitting unit 321, the rear-side light-emitting unit 322, the right-side light-emitting unit 323 and the left-side light-emitting unit 324 are provided by infrared LEDs (Light-Emitting Diodes) and respectively emit a front-side infrared ray L1, a rear-side infrared ray L2, a right-side infrared ray L3 and a left-side infrared ray L4 each having directionality under the control of the controller 34. The front-side infrared ray L1, the rear-side infrared ray L2, the right-side infrared ray L3 and the left-side infrared ray L4 emit light in a manner that the emitted lights do not overlap.

Specifically, as shown, in FIG. 1, the front-side infrared ray L1 and the rear-side infrared ray L2 are emitted in mutually separating directions with optical axes thereof substantially aligned in a plan view (i.e. from above). The right-side infrared ray L3 and the left-side infrared ray L4 are emitted in mutually separating directions with optical axes thereof substantially aligned in a plan view. The optical axes of the front-side infrared ray L1 and the right-side infrared ray L3 are orthogonal with each other. Further, the front-side infrared ray L1, the rear-side infrared ray L2, the right-side infrared ray L3 and the left-side infrared ray 1A are emitted obliquely upward in a side view (i.e. seen laterally).

It should be noted that the advance direction of the front-side infrared ray L1 is a first direction the invention, the advance direction of the rear-side infrared ray L2 is a second direction of the invention, and the advance direction of the right-side infrared ray L3 and the left-side infrared ray L4 are a third direction of the invention,

The memory unit 33 stores image data for displaying the right-eye image Pm and the left-eye image Ph.

The controller 34 includes a display controller 341 and a vision controller 342 provided by processing a program and data stored in the memory unit 33 by a CPU (Central Processing Unit).

The display controller 341 alternately displays the right-eye image Pm and the left-eve image Ph on the display surface 311 based on the image data stored in the memory unit 33. The memory unit 33 may store in advance image data corresponding to each of the right-eye image Pm and the left-eye image Ph, and the display controller 341 may alternately display the right-eye image Pm and the left-eye image Ph based on the image data. Alternatively, an image generating unit (not shown) may generate the right-eye image Pm and the left-eye image Ph with binocular parallax based on the image data corresponding to a single image stored in the memory unit 33 and the display controller 341 may alternately display the right-eye image Pm and the left-eye image Ph. Further, the display controller 341 switches the right-eye image Pm and the left-eye image Ph, for instance, every 1/120 seconds,

It should be rioted that the display controller 341 displays the right-eye image Pm and the left-eye image Ph for a front-side user U1 positioned near the front portion 313 relative to the display surface 311 such that the front-side user U1 can correctly recognize the stereoscopic effect of the stereoscopic image. In other words, in order to show a stereoscopic image of an object having textures, height (vertical relationship) and/or depth (front and back relationship), the display controller 341 displays the right-eye image Pm and the left-eye image Ph such that the front-side user U1 can correctly recognize the textures, height and depth of the object. The right-eye image Pm and the left-eye image Ph correspond respectively to the right-eye image and left-eye image for the front-side user positioned near the side of the display surface in the first direction of the invention.

The vision controller 342 allows the right-eye image Pm to he visible to the right eye of the front-side user U1 and allows the left-eye image Ph to be visible to the left eye of the front-side user U1. Further, the vision controller 342 allows the right-eye image Pm to be visible to the left eye of the user U (a rear-side user U2) positioned near the rear portion 314 relative to the display surface 311 and allows the left-eye image Ph to be visible to the right eye of the rear-side user U2.

The vision controller 342 includes a signal generating unit 343 and a signal output unit 344.

The signal generating unit 343 generates a front-side control signal (a first control signal) for closing only the left-eye shutter 23 at a time When the right-eye image Pm is displayed and for closing only the right-eye shutter 22 at a time when the left-eye image Ph is displayed. Further, the signal generating unit 343 generates a rear-side control signal (a second control signal) for closing only the right-eye shutter 22 at a time when the right-eye image Pm is displayed and for closing only the left-eye shutter 23 at a time when the left-eye image Ph is displayed. Still further, the signal generating unit 343 generates a right-side control signal and a left-side control signal in a form of a third control signal for opening both of the right-eye Shutter 22 and the left-eye shutter 23 both at the time when the right-eye image Pm is displayed and at the time when the left-eye image Ph is displayed. In other words, the signal generating unit 343 generates the right-side control signal and the left-side control signal constantly opening both of the right-eye shutter 22 and the left-eye shutter 23.

The signal output unit 344 outputs the front-side control signal through the front-side infrared ray L1. Further, the signal output unit 344 outputs the rear-side control signal through the rear-side infrared ray L2. Still further, the signal output unit 344 outputs the right-side control signal through the right-side infrared ray L3 and outputs the left-side control signal through the left-side infrared ray L4. In other words, the signal output unit 344 outputs the front-side control signal, the rear-side control signal, the right-side control signal and the left-side control signal in mutually orthogonal directions in a plan view of the display surface 311.

Since the signal output unit 344 outputs the control signals as described above, the stereoscopic glasses 2 (first stereoscopic glasses 2A) of the user L1 (the front-side user U1) positioned near the front portion 313 of the display surface 311 receive only the front-side control signal, the stereoscopic glasses 2 (second stereoscopic glasses 213) of the user U (the rear-side user U2) positioned near the rear portion 314 receive only the rear-side control signal, the stereoscopic glasses 2 of the user U positioned near the right portion 315 receive only the right-side control signal and the stereoscopic glasses 2 of the user U positioned near the left portion 316 receive only the left-side control signal.

### Operation of Stereoscopic System

Next, an operation of the stereoscopic system 1 will be described below.

It should be noted that an instance in which a stereoscopic image showing an airplane Q2 flying over a cloud Q1 (I.e. the airplane Q2 is located above the cloud Q1) is to be recognized by the user U using the stereoscopic system 1 will be described herein.

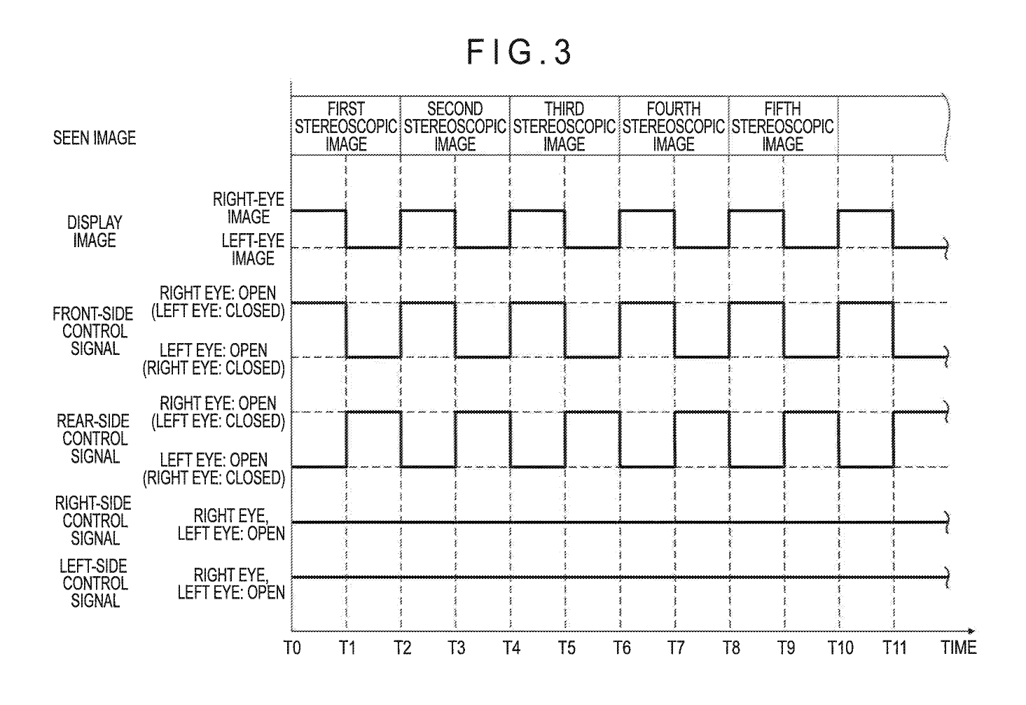

Initially, when the display controller 341 of the stereoscopic display 3 in the stereoscopic system 1 detects an operation for displaying the stereoscopic image, the display controller 341 judges that the right-eye image Pm and the left-eye image Ph are to be alternately displayed on the display surface 311 as shown in FIG. 3. Specifically, the display controller 341 judges that the right-eye image Pm forming an Nth stereoscopic image is to be displayed between a time T(N−1) (N being an integer of 1 or more) and a time T(N) and the left-eye image Ph forming the N-th stereoscopic image is to be displayed from the time T(N) to a time T(N+1).

Further, the stereoscopic display 3 generates the front-side control signal, the rear-side control signal, the right-side control signal and the left-side control signal with the signal generating unit 343 before displaying the right-eye image Pm or the left-eye image Ph.

Specifically, the signal generating unit 343 generates the front-side control signal for closing the left-eye shutter 23 and opening the right-eye shutter 22 in a period between the time T(N−1) and the time T(N) when the right-eye image Pm is being displayed and for closing the left-eye shutter 23 and opening the right-eye shutter 22 in a period between the time T(N) and the time T(N+1) when the left-eye image Ph is being displayed.

Further, the signal generating unit 343 generates the rear-side control signal for closing the right-eye shutter 22 and opening the left-eye shutter 23 in the period between the time T(N−1) and the time TEN) when the right-eye image Pm is being displayed and for closing the right-eye shutter 22 and opening the left-eye shutter 23 in the period between the time T(N) and the time T(N−1) when the left-eye image Ph is being displayed.

Further, the signal generating unit 343 generates the right-side control signal and the left-side control signal for opening both of the right-eye shutter 2.2 and the left-eye shutter 23 both in the period between the time T(N−1) and the time T(N) when the right-eye image Pm is being displayed and in the period between the time T(N) and the time T(N+1) When the left-eye image Ph is being displayed (i.e. between the time T(N−1) and the time T(N+1).

Then, the stereoscopic display 3 alternately displays the right-eye image Pm and the left-eye image Ph forming the N-th stereoscopic image with the display controller 341. Further, the stereoscopic display 3 outputs the front-side control signal, the rear-side control signal, the right-side control signal and the left-side control signal corresponding to the N-th stereoscopic image by the signal output unit 344 through the front-side infrared ray L1, the rear-side infrared ray L2, the right-side infrared ray L3 and the left-side infrared ray L4 immediately before alternately displaying the right-eye image Pm and the left-eye image Ph corresponding to the N-th stereoscopic image.

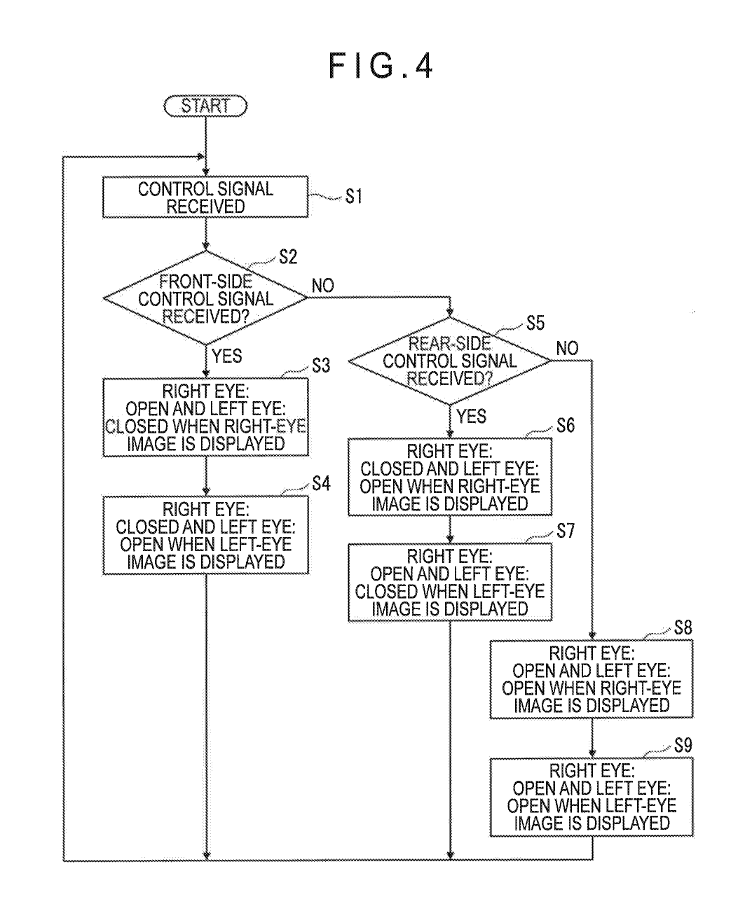

On the other hand, When the stereoscopic glasses 2 worn by the user U detect an operation on a switch (not shown), the stereoscopic glasses 2 receive the control signal (the front-side control signal, the rear-side control signal, the right-side control signal or the left-side control signal) outputted by the stereoscopic display 3 as shown in FIG. 4 (step S1). Specifically, the stereoscopic glasses 2 receive one of the front-side infrared ray L1, the rear-side infrared ray L2, the right-side infrared ray L3 and the left-side infrared ray L4 through the light receiver 24. Then, the shutter controller 25 receives the control signal outputted through the received infrared ray (the front-side infrared ray L1, the rear-side infrared ray L2, the right-side infrared ray L3 or the left-side infrared ray L4).

Subsequently, the shutter controller 25 of the stereoscopic glasses 2 judges whether or not the control signal received in step S1 is the front-side control signal (step S2). When the shutter controller 25 judges in step S2 that the control signal is the front-side control signal, the shutter controller 25 closes the left-eye shutter 23 and opens the right-eye shutter 22 in the period between the time T(N−1) and the time TEN) when the right-eye image Pm is being displayed (step S3), and closes the right-eye shutter 22 and opens the left-eye shutter 23 in the period between the time T(N) and the time T(N+1) when the left-eye image Ph is being displayed (step S4). Then, the shutter controller 25 performs the processing in step S1 after the processing in step S4.

As shown in FIG. 1, when the front-side user U1 wearing the first stereoscopic glasses 2A is positioned near the front portion 313 of the display surface 311, the first stereoscopic glasses 2A receive the front-side control signal in step S2. Then, as the shutter controller 25 of the first stereoscopic glasses 2A performs the processing in step S3 and step S4, the front-side user U1 sees, for instance, the right-eye image Pm displayed in a period between a time T0 and a time T1 only with the right eye and sees the left-eye image Ph displayed in a period between the time T1 and a time T2 only with the left eye.

Accordingly, the front-side user U1 can see a first stereoscopic image showing the airplane Q2 located above the cloud Q1, for instance, in the period between the time T0 and the time T2 with the stereoscopic effect intended to be expressed by the first stereoscopic image.

Further, when the shutter controller 25 of the stereoscopic glasses 2 judges that the control signal is not the front-side control signal in step S2 as shown in FIG. 4, the shutter controller 25 judges whether or not the control signal is the rear-side control signal (step S5). When the shutter controller 25 judges in step S5 that the control signal is the rear-side control signal, the Shutter controller 25 based on the rear-side control signal closes the right-eye shutter 22 and opens the left-eye shutter 23 in the period between the time T(N−1) and the time T(N) when the right-eye image Pm is being displayed (step S6), and closes the left-eye shutter 23 and opens the right-eye shutter 22 in the period between the time T(N) and the time T(N+1) when the left-eye image Ph is being displayed (step S7). Then, the shutter controller 25 performs the processing in step S1 after the processing in step S7.

As shown in FIG. 1, when the rear-side user U2 wearing the second stereoscopic glasses 2B is positioned near the rear portion 314 of the display surface 311, the second stereoscopic glasses 2B receive the rear-side control signal in step S1. Then, when the shutter controller 25 of the second stereoscopic glasses 2B performs the processing in step S6 and step S7, the rear-side user U2 sees, for instance, the right-eye image Pm displayed in the period between the time T0 and the time T1 only with the left eye and sees the left-eye image Ph displayed in the period between the time T1 and the time T2 only with the right eye. In other words, the rear-side user U2 sees only with the left eye the right-eye image Pm viewed by the right eye of the font-side user U1 and sees only with the right eye the left-eye image Ph viewed by the right eye of the front-side user

Accordingly, the rear-side user U2 can see the first stereoscopic image of the airplane Q2 located above the cloud Q1, for instance, in the period between the time T0 and the time T2 with the stereoscopic effect intended to be expressed by the first stereoscopic image, in the same manner as the front-side user U1.

Further, as shown in FIG. 4, when the shutter controller 25 of the stereoscopic glasses 2 judges in step S5 that the control signal is not the rear-side control signal (i.e. When it is judged, the right-side control signal or the left-side control signal is received), the shutter controller 25 based on the right-side control signal or the left-side control signal opens both the right-eye shutter 22 and the left-eye shutter 23 in the period between the time T(N−1) and the time T(N) when the right-eye image Pm is being displayed (step S8), and opens both the right-eye shutter 22 and the left-eye Shutter 23 also in the period between the time T(N) and the time T(N−1) when the left-eye image Ph is being displayed (step S9) based on the right-side control signal or the left-side control signal. Then, the shutter controller 25 performs the processing in step S1 after the processing in step S9.

Specifically, though not shown in FIG. 1, when the rear-side user L1 wearing the stereoscopic glasses 2 is positioned near the right portion 315 of the display surface 311, the second stereoscopic glasses 2 receive the right-side control signal in step S1. Then, when the shutter controller 25 of the stereoscopic glasses 2A performs the processing in step S8 and step S9, the user U sees, for instance, the right-eye image Pm displayed in the period between the time T0 and the time T1 with both eyes and sees the left-eye image Ph displayed in the period between the time T1 and the time T2 also with both eyes.

When the user U positioned near the right portion 315 or the left portion 316 of the display surface 311 sees the right-eye image Pm with the right eye and sees the left-eye image Ph with the left eye (or conversely sees the right-eye image Pm with the left eye and sees the left-eye image Ph with the right eye), since the right-eye image Pm and the left-eye image Ph have binocular parallax, the N-th stereoscopic image may become totally invisible. In contrast, since the user U sees the right-eye image Pm and the left-eye image Ph with both eyes, the N-th stereoscopic image becomes visible.

### Effects of Stereoscopic System

The above-described first exemplary embodiment provides the following effects.

(1) The stereoscopic display 3 generates the front-side control signal for closing only the left-eye shutter 23 at the time when the right-eye image Pm is displayed on the display surface 311 facing upward and for closing only the right-eye shutter 22 at the time when the left-eye image Ph is displayed and the rear-side control signal for closing only the right-eye shutter 22 at the time when the right-eye image Pm is displayed and for closing only the left-eye shutter 23 at the time when the left-eye image Ph is displayed. Further, the stereoscopic display 3 outputs the front-side control signal through the front-side infrared ray L1, emitted from the front portion 313 and outputs the rear-side control signal through the rear-side infrared ray L2 emitted in a direction opposite to that of the front-side infrared ray L1 in a plan view of the display surface 311. Then, the stereoscopic display 3 alternately displays the right-eye image Pm and the left-eye image Ph on the display surface 311.

Accordingly, the front-side user U1 positioned near the front portion 313 of the display surface 311 can see the right-eye image Pm only with the right eye and see the left-eye image Ph only with the left eye. Further, the rear-side user U2 positioned near the rear portion 314 can see the right-eye image Pm only with the left eye and sees the left-eye image Ph only with the right eye. Thus, even when the front-side user U1 and the rear-side user U2 see the display surface 311, from opposite points across the display surface 311, both the front-side user U1 and the rear-side user U2 can feel the stereoscopic effect to be expressed by the N-th stereoscopic image.

Especially, the stereoscopic glasses 2 are arranged to control the open/close operation of the right-eye shutter 22 and the left-eye shutter 23 based on the front-side control signal and the rear-side control signal outputted by the stereoscopic display 3. Accordingly, even when the front-side user U1 moves from a point near the front portion 313 to a point near the rear portion 314, the front-side user U1 still can feel the stereoscopic effect to be expressed by the N-th stereoscopic image while wearing the first stereoscopic glasses 2A.

(2) The stereoscopic display 3 generates the right-side control signal and the left-side control signal for opening both of the right-eye shutter 22 and the left-eye shutter 23 both at the time when the right-eye image Pm is displayed and at the time when the left-eye image Ph is displayed. Further, the stereoscopic display 3 outputs the right-side control signal through the right-side infrared ray L3 emitted in the direction orthogonal to the front-side infrared ray L1 in a plan view of the display surface 311 and outputs the left-side control signal through the left-side infrared ray L4 emitted in the direction opposite to the right-side infrared ray L3 in the plan view of the display surface 311.

Accordingly, the user U positioned near the right portion 315 or the left portion 316 of the display surface 311 can see both the right-eye image Pm and the left-eye image Ph with both eyes. Thus, even if, for instance, the front-side user U1 positioned near the front portion 313 of the display surface 311 moves via the right portion 315 to the rear portion 314, the N-th stereoscopic image can be kept from being totally invisible in the course of the movement.

### Second Exemplary Embodiment

Next, a second exemplary embodiment of the invention will be described below.

Should be noted that the same components as those in the first exemplary embodiment will be denoted by the same names and reference numerals and description thereof will be simplified or omitted. It should also be noted that the same arrangements as those in the first exemplary embodiment will be denoted by the same names and description thereof will be simplified.

### Arrangement of Stereoscopic System

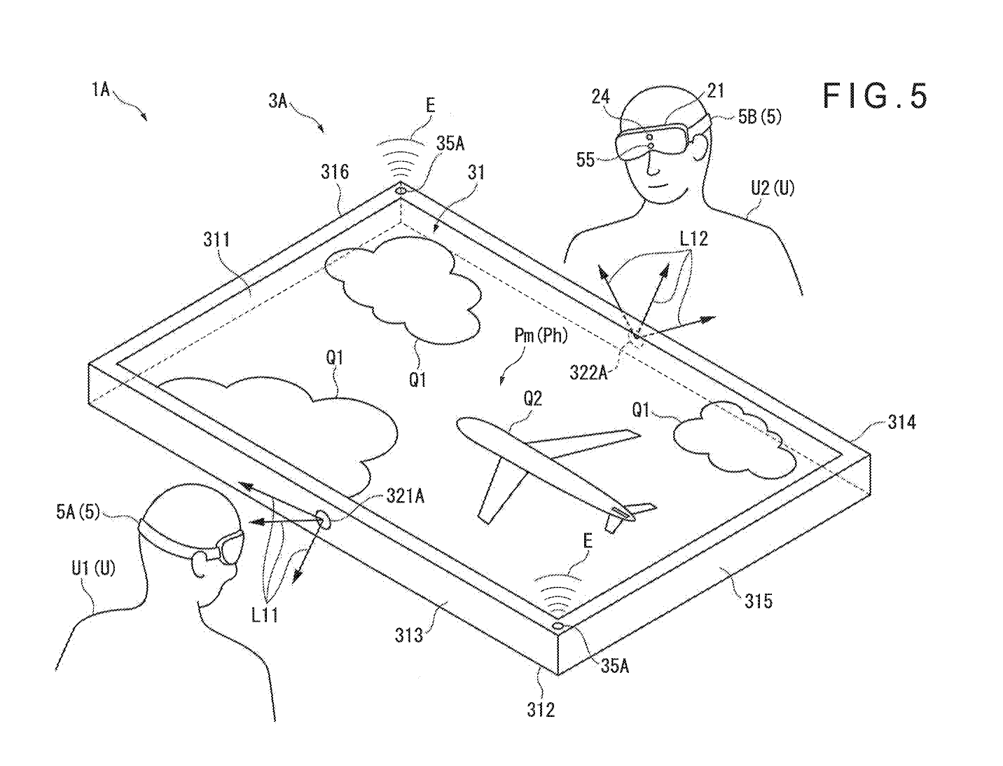

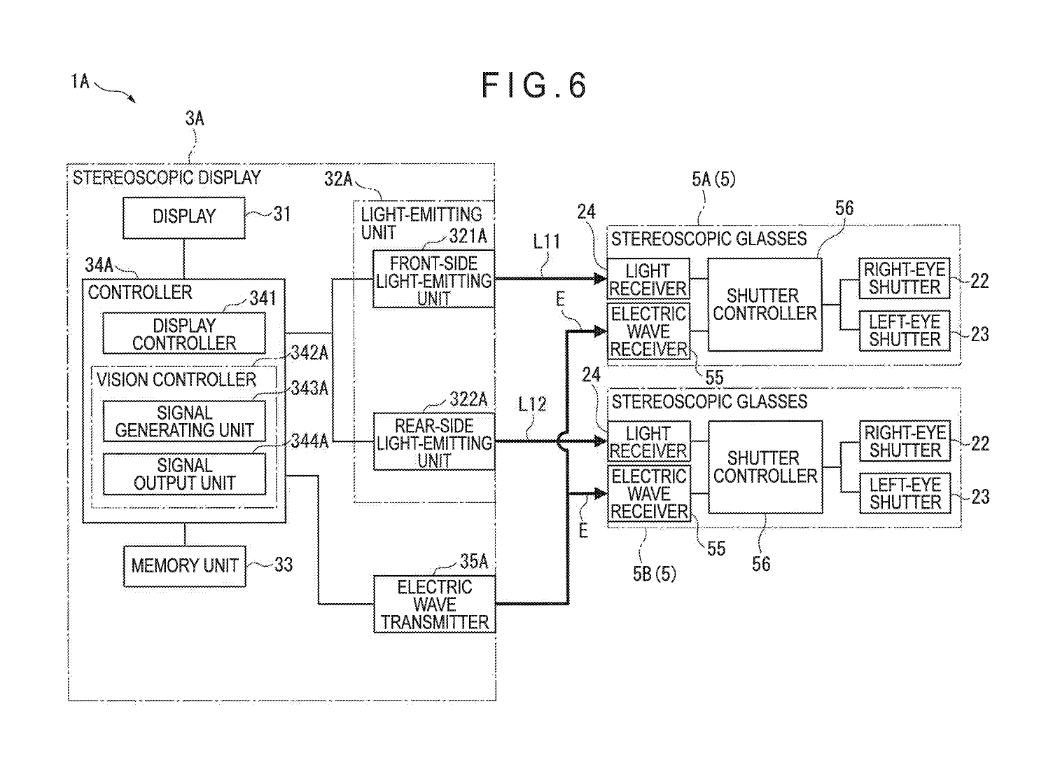

As shown in FIGS. 5 and 6, a stereoscopic system 1A includes stereoscopic glasses 5 and a stereoscopic display 3A.

The attachment portion 21 of the stereoscopic glasses 5 includes the right-eye shutter 22, the left-eye shutter 23, the light receiver 24, an electric wave receiver 55 and a shutter controller 56.

The electric wave receiver 55 is, for instance, disposed on a front side of the attachment portion 21 and is adapted to receive an electric wave E transmitted by the stereoscopic display 3A under the control of the shutter controller 56.

The shutter controller 56 controls open/close of the right-eye shutter 22 and the left-eye shutter 23 based on the control signal outputted through the front-side infrared ray L11 and the rear-side infrared ray L12 and a switch signal outputted through the electric wave E.

The stereoscopic display 3A includes the display 31, a light-emitting unit 32A, the memory unit 33, a controller 34A and an electric wave transmitter 35A.

The display 31 includes the display surface 311 having a rectangular shape. The display 31 is housed in the rectangular frame 312 with the display surface 311 facing upward. The frame 312 includes the front portion 313 defining one of long sides of the rectangular shape, the rear portion 314 that defines the other one of the long sides of the rectangular shape, the right portion 315 that defines one of short sides of the rectangular shape and the left portion 316 that defines the other one of short sides.

The light-emitting unit 32A includes a single front-side light-emitting unit 321A (the first light-emitting unit) disposed substantially at the center of the front portion 313 and a single rear-side light-emitting unit 322A (the second light-emitting unit) disposed substantially at the center of the rear portion 314.

The front-side light-emitting unit 321A and the rear-side light-emitting unit 322A each include a plurality of infrared LEDs (not shown). The infrared LEDs of the front-side light-emitting unit 321A and the rear-side light-emitting unit 322A emit the front-side infrared ray L11 (the first infrared ray) and the rear-side infrared ray L12 (the second infrared ray) each having directionality in a plurality of directions, respectively,

Specifically, as shown in FIG. 5, the front-side infrared ray L11 and the rear-side infrared ray L12 are emitted with optical axes thereof substantially aligned in a plan view and in mutually separating directions. Further, the front-side infrared ray L11 and the rear-side infrared ray L12 are emitted obliquely upward in a side view.

The advance direction of the front-side infrared ray L11 is the first direction of the invention and the advance direction of the rear-side infrared ray L12 is the second direction of the invention.

it should be noted that the front-side light-emitting unit 321A may be provided in plural at the front portion 313 and/or the rear-side light-emitting unit 322A may be provided in plural at the rear portion 314.

The electric wave transmitter 35A is provided at each of mutually opposing corners of the frame 312. The electric wave transmitter 35A outputs the electric wave E without directionality under the control of the controller 34A. Since the electric, wave E is non-directional, the electric wave F is received by both the electric wave receiver 55 of the first stereoscopic glasses 5A of the front-side user U1 and the electric wave receiver 55 of a second stereoscopic glasses 5B of the rear-side user U2.

It should he noted that the location and the number of the electric wave transmitter 3 5A are not limited to the above but may be arranged otherwise.

The controller 34A includes the display controller 341 and a vision controller 342A provided by processing a program and data stored in the memory unit 33 by a CPU (Central Processing Unit). The vision controller 342A includes a signal generating unit 343A and a signal output unit 344A.

The signal generating unit 343A generates a switch signal for closing only the left-eye shutter 23 at a time when the right-eye image Pm is displayed and for closing only the right-eye shutter 22 at a time when the left-eye image Ph is displayed.

Further, the signal generating unit 343A generates a front-side control signal (a first control signal) for not changing the polarity of the switch signal. Still further, the signal generating unit 343A generates a rear-side control signal (a second control signal) for changing the polarity of the switch signal.

When the polarity of the switch signal is unchanged, the stereoscopic glasses 5 receiving the switch signal operate to close only the left-eye shutter 23 at the time when the right-eye image Pm is displayed and close only the right-eye shutter 22 at the time when the left-eye image Ph is displayed.

When the polarity of the switch signal is changed, the stereoscopic glasses 5 receiving the switch signal operate to close only the right-eye shutter 22 at the time when the right-eye image Pm is displayed and close only the left-eye shutter 23 at the time when the left-eye image Ph is displayed.

The signal output unit 344A outputs the front-side control signal through the front-side infrared ray L11. Further, the signal output unit 344A outputs the rear-side control signal through the rear-side infrared ray L12. In other words, the signal output unit 344A outputs the front-side control signal and the rear-side control signal in directions not overlapping with each other in a plan view of the display surface 311.

Further, the signal output unit 344A outputs the switch signal through the electric wave E.

Since the signal output unit 344A outputs the control signals and the switch signal as described above, the stereoscopic glasses 5 (first stereoscopic glasses 5A) of the user U (the front-side user U1) positioned near the front portion 313 of the display surface 311 can receive only the front-side control signal and the switch signal, whereas the stereoscopic glasses 2 (second stereoscopic glasses 5B) of the user U (the rear-side user U2) positioned near the rear portion 314 can receive only the rear-side control signal and the switch signal.

### Operation of Stereoscopic System

Next, an operation of the stereoscopic system 1A will be described below.

It should be noted that an instance in which a stereoscopic image showing an airplane Q2 flying over a cloud Q1 (i.e., the airplane Q2 located above the cloud Q1) is to be recognized by the user U using the stereoscopic system 1A will he described herein,

Initially, when the stereoscopic display 3A of the stereoscopic system 1A detects an operation for displaying the stereoscopic image, the stereoscopic display 3A generates the front-side control signal, the rear-side control signal and the switch signal by the signal generating unit 343A before displaying the right-eye image Pm or the left-eye image Ph.

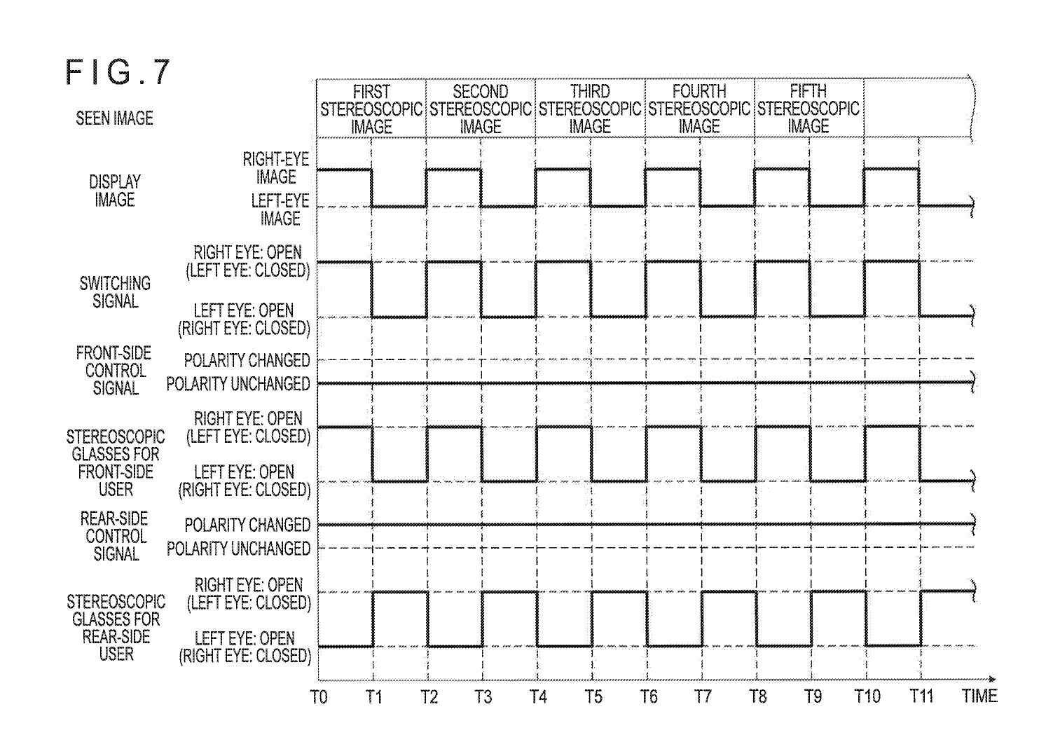

Specifically, as shown in FIG. 7, the signal generating unit 343A generates the switch signal for closing the left-eye shutter 23 and opening the right-eye shutter 22 in the period between the time T(N−1) (N being an integer of 1 or more) and the time T(N) when the right-eye image Pm is being displayed, and for closing the left-eye shutter 23 and opening the right-eye shutter 22 in the period between the time T(N) and the time T(N+1) when the left-eye image Ph is being displayed.

In addition, the signal generating unit 343A generates the front-side control signal for not changing the polarity of the switch signal both in the period between the time T(N−1) and the time T(N) when the right-eye image Pm is being displayed and in the period between the time T(N) and the time T(N+1) when the left-eye image Ph is being displayed (i.e. between the time T(N−1) and the time T(N+1). Further, the signal generating unit 343A generates a rear-side control signal for changing the polarity of the switch signal in the period between the time T(N−1) and the time T(N+1).

Then, the stereoscopic display 3A alternately displays the right-eye image Pm and the left-eye image Ph forming the N-th stereoscopic image with the display controller 341. Further, the stereoscopic display 3A outputs the front-side control signal, the rear-side control signal and the switch signal corresponding to the N-th stereoscopic image by the signal output unit 344A respectively through the front-side infrared ray L1, the rear-side infrared ray L2 and the electric wave E immediately before alternately displaying the right-eye image Pm and the left-eye image Ph corresponding to the N-th stereoscopic image.

On the other hand, when the stereoscopic glasses 5 worn by the user U detect an operation on a switch (not shown), the stereoscopic glasses 2 receive the front-side control signal, the rear-side control signal and the switch signal.

As shown in FIG. 5, when the front-side user U1 wearing the first stereoscopic glasses 5A is positioned near the front portion 313 of the display surface 311, the first stereoscopic glasses 5A receive the switch signal and the front-side control signal. Then, the shutter controller 56 of the first stereoscopic glasses 5A controls the right-eye shutter 22 and the left-eye shutter 23 based on the switch signal and the switch signal for not changing the polarity of the switch signal. With the above control, the front-side user U1 can see the right-eye image Pm only with the right eye and see the left-eye image Ph only with the left eye.

Accordingly, the front-side user U1 can see the N-th stereoscopic image showing the airplane Q2 located above the cloud Q1 with the stereoscopic effect intended to be expressed by the N-th stereoscopic image.

On the other hand, when the rear-side user U12 wearing the second stereoscopic glasses 5B is positioned near the rear portion 314 of the display surface 311, the second stereoscopic glasses 5B receive the switch signal and the rear-side control signal for changing the polarity of the switch signal to control the right-eye shutter 22 and the left-eye shutter 23. With the above control, the rear-side user U2 can see the right-eye image Pm only with the left eye and see the left-eye image Ph only with the right eye.

Accordingly, in the same manner as the front-side user U1, the rear-side user U2 can see the N-th stereoscopic image in which the airplane Q2 is located above the cloud Q1 with the stereoscopic effect intended to the expressed by the N-th stereoscopic image.

### Effects of Stereoscopic System

The above-described second exemplary embodiment provides the following effects.

(3) The stereoscopic display 3A generates the switch signal for closing only the left-eye shutter 23 at the time when the right-eye image Pm is displayed on the display surface 311 facing upward and for closing only the right-eye shutter 22 at the time when the left-eye image Ph is displayed on the display surface 311. Further, the stereoscopic display 3A generates the front-side control signal for not changing the polarity of the switch signal and the rear-side control signal for changing the polarity of the switch signal. The stereoscopic display 3A outputs the front-side control signal through the front-side infrared ray L1 emitted from the front portion 313 and outputs the rear-side control signal through the rear-side infrared ray L12 emitted in the direction opposite to that of the front-side infrared ray L11 in a plan view of the display surface 311. Further, the stereoscopic display 3A outputs the switch signal through the electric wave E. Then, the stereoscopic display 3A alternately displays the right-eye image Pm and the left-eye image on the display surface 311.

Accordingly, the front-side user U1 positioned near the front portion 313 of the display surface 311 can see the right-eye image Pm only with the right eye and see the left-eye image Ph only with the left eye. Further, the rear-side user U2 positioned near the rear portion 314 can see the right-eye image Pm only with the left eye and see the left-eye image Ph only with the right eye. Thus, even when the front-side user U1 and the rear-side user U2 see the display surface 311 from opposite points across the display surface 311, both the front-side user U1 and the rear-side user U2 can feel the stereoscopic effect to he expressed by the N-th stereoscopic image.

Especially, the stereoscopic glasses 5 are arranged to control the open/close operation of the right-eye shutter 22 and the left-eye shutter 23 based on the front-side control signal, the rear-side control signal and the switch signal outputted by the stereoscopic display 3A. Accordingly, even when the front-side user U1 moves from a point near the front portion 313 to a point near the rear portion 314, the front-side user U1 still can feel the stereoscopic effect to he expressed by the N-th stereoscopic image while wearing the first stereoscopic glasses 5A.

### Modification(s)

it should be understood that the scope of the present invention is not limited to the above-described exemplary embodiment(s) but includes modifications and improvements as long as the modifications and improvements are compatible with the invention.

The display surface 311 may not be rectangular but may be defined in any shape such as a polygon including triangle and pentagon, a true circle and an ellipse.

The frame 312 including the front-side light-emitting unit 321, the rear-side light-emitting unit 322, the right-side light-emitting unit 323 and the left-side light-emitting unit 32.4 may be arranged in a manner detachable from the display surface 311 and the frame 312 may be arranged to be attachable to an existing stereoscopic display. In the above arrangement, a program may he installed in a controller of the stereoscopic display on which the frame 312 is attached so that the controller serves as the controller 34 in the above exemplary embodiment.

Further, the stereoscopic display 3 in the first exemplary embodiment may not be provided with the right-side light-emitting unit 323 and the left-side light-emitting unit 324, the signal generating unit 343 may not be provided with a function for generating the right-side control signal and the left-side control signal, and the shutter controller 25 of the stereoscopic glasses 2 may be provided with a function for opening both the right-eye shutter 22 and the left-eye shutter 23 at a time when both the front-side control signal and the rear-side control signal cannot be received.

According to the above arrangement, though the stereoscopic display 3 performs displaying of the right-eye image Pm and the left-eye image Ph and outputting of the front-side control signal and the rear-side control signal as shown in FIG. 4, the stereoscopic display 3 does not output the right-side open/close signal and the left-side control signal. Accordingly, the stereoscopic glasses 2 of the user U positioned near the right portion 315 or the left portion 316 of the display surface 311 cannot receive the control signal.

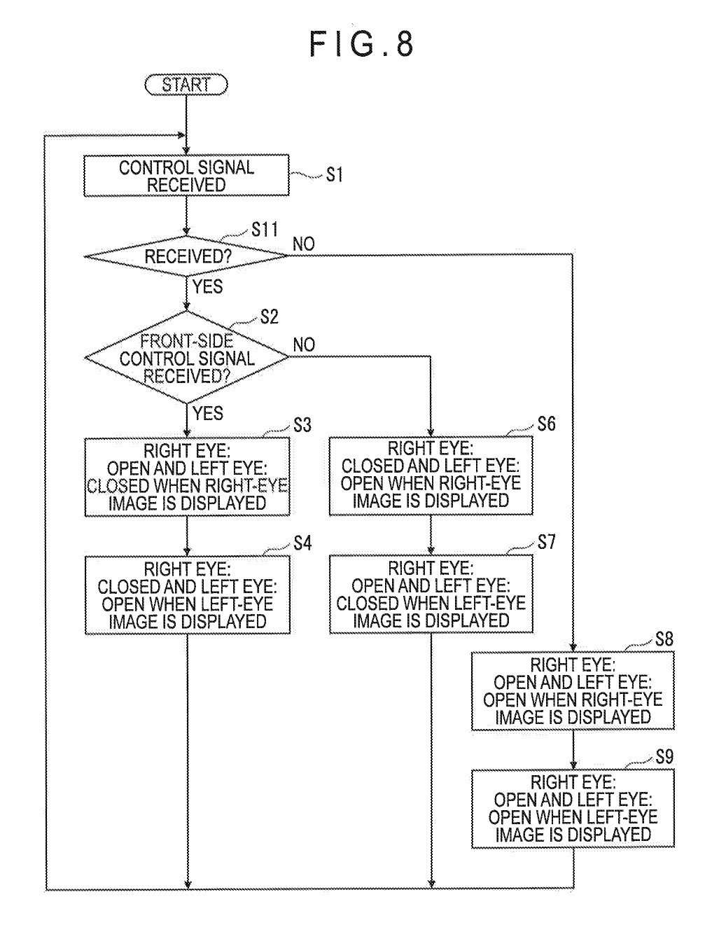

On the other hand, the stereoscopic glasses 2 of the user U judge whether the control signal can be received or not after the processing in step S1 as shown in FIG. 8 (step S11). Then, when the stereoscopic glasses 2 judge that both the front-side control signal and the rear-side control signal cannot be received in step S11, the stereoscopic glasses 2, perform the processing in steps S8 and 59 and open the right-eye shutter 22 and the left-eye shutter 23 both at the time when the right-eye image Pm is displayed and at the time when the left-eye image Ph is displayed. In other words, when the user U is positioned near the right portion. 315 or the left portion 316 of the display surface 311, irrespective of the absence of the right-side light-emitting unit 323 and the left-side light-emitting unit 324 on the stereoscopic display 3, the stereoscopic glasses 2 can perform the same processing as in steps 58 and S9 in the above exemplary embodiment.

When judging that the control signal can be received in step S11, the stereoscopic glasses 2 perform the processing in step S2. Then, when judging that the front-side control signal can be received in step S2, the stereoscopic glasses 2 perform the processing in steps S3 and S4, whereas, when judging that the front-side control signal is not received (i.e. when judging that the rear-side control signal is received), the stereoscopic glasses 2 perform the processing in steps S6 and S7.

The stereoscopic display 3 may be used as a display for a portable or desktop computer, a PDA. (Personal Digital Assistant), a cellular phone and a content reproduction device. Further, the stereoscopic display 3 may be used for displaying business information and in-car/train information or for operating an electronic device.

### EXPLANATION OF CODE(S)

2, 5 . . . stereoscopic glasses

3, 3A . . . stereoscopic display

22 . . . right-eye shutter

23 . . . left-eye shutter

25 . . . shutter controller

31 . . . display

311 . . . display surface

321, 321A . . . front-side light-emitting unit (first light-emitting unit)

322, 322A . . . rear-side light-emitting unit (second light-emitting unit)

323 . . . right-side light-emitting unit (third light-emitting unit)

324 . . . left-side light-emitting unit (third light-emitting unit)

341 . . . display controller

342, 342A . . . vision controller

343 . . . signal generating unit

344 . . . signal output unit

L1, L11 . . . front-side infrared ray (first infrared ray)

L2, L12 . . . rear-side infrared ray (second infrared ray)

L3 . . . right-side infrared ray (third infrared ray)

L4 . . . left-side infrared ray (third infrared ray)

1. A method for displaying a stereoscopic image to a user wearing stereoscopic glasses comprising a right-eye shutter facing a right eye of the user, a left-eye shutter facing a left eye of the user and a shutter controller that is configured to control the right-eye shutter and the left-eye shutter based on a control signal, the stereoscopic image being seen by showing the user a right-eye image and a left-eye image with binocular parallax, the method comprising:
using a display device comprising: a display with a display surface facing upward; a first light-emitting unit that emits a first infrared ray directional in a first direction toward an outside of the display surface in a plan view of the display surface; a second light-emitting unit that emits a second infrared ray directional in a second direction opposite to the first direction in the plan view of the display surface; and a third light-emitting unit that emits a third infrared ray directional in a third direction orthogonal to the first direction in the plain view of the display surface;
alternately displaying on the display surface the right-eye image and the left-eye image for a front-side user positioned at a side of the display surface in the first direction; and
controlling a vision of the user so that: in accordance with a first control signal transmitted through the first infrared ray, when the user is positioned at a side of the display surface in the first direction, the right-eye image for the front-side user is visible to the right eye of the user at the side in the first direction while the left-eye image for the front-side user is visible to the left eye of the user at the side in the first direction; in accordance with a third control signal transmitted through the third infrared ray, when the user is positioned at side of the display surface in the third direction, the right-eye image for the front-side user and the left-eye image for the front-side user are visible to the right eye and the left eye of the user at the side in the third direction; and in accordance with a second control signal transmitted through the second infrared ray, when the user is positioned at a side in the second direction of the display surface, the right-eye image for the front-side user is visible to the left eye of the user positioned at the side in the second direction while the left-eye image for the front-side user is visible to the right eye of the user positioned at the side in the second direction.

2. The method for displaying a stereoscopic image according to claim 1, wherein
the controlling of the vision comprises:
generating: the first control signal for closing only the left-eye shutter at a time when the right-eye image for the front-side user is displayed and closing only the right-eye shutter at a time when the left-eye image for the front-side user is displayed; the third control signal for opening both the right-eye shutter and the left-eye shutter both at the time when the right-eye image for the front-side user is displayed and at the time when the left-eye image for the front-side user is displayed; and the second control signal for closing only the right-eye shutter at the time when the right-eye image for the front-side user is displayed and for closing only the left-eye shutter at the time when the left-eye image for the front-side user is displayed; and
transmitting the first control signal through the first infrared ray, transmitting the third control signal through the third infrared ray and transmitting the second control signal through the second infrared ray.

3. (canceled)

4. (canceled)

5. A stereoscopic display that allows visualization of a stereoscopic image to a user wearing stereoscopic glasses comprising a right-eye shutter facing a right eye of the user, a left-eye shutter facing a left eye of the user and a shutter controller that controls the right-eye shutter and the left-eye shutter based on a control signal, the stereoscopic image being seen by showing the user a right-eye image and a left-eye image with binocular parallax, the stereoscopic display comprising:
a display with a display surface facing upward;
a first light-emitting unit that emits a first infrared ray directional in a first direction toward an outside of the display surface in a plan view of the display surface;
a second light-emitting unit that emits a second infrared ray directional in a second direction opposite to the first direction in the plan view of the display surface;
a third light-emitting unit that emits a third infrared ray direction in a third direction orthogonal to the first direction in the plan view of the display surface;
a display controller that alternately displays on the display surface the right-eye image and the left-eye image for a front-side user positioned at a side of the display surface in the first direction; and
a vision controller that controls a vision of the user so that: in accordance with a first control signal transmitted through the first infrared ray, when the user is positioned at the side of the display surface in the first direction, the right-eye image for the front-side user is visible to a right eye of the user at the side in the first direction while the left-eye image for the front-side user is visible to a left eye of the user at the side in the first direction; in accordance with a third control signal transmitted through the third infrared ray, when the user is positioned at a side of the display surface in the third direction, the right-eye image for the front-side user and the left-eye image for the front-side user are visible to the right eye and the left eye of the user at the side in the third direction; and in accordance with a second control signal transmitted through the second infrared ray, when the user is positioned at a side of the display surface in the second direction, the right-eye image for the front-side user is visible to the left eye of the user positioned at the side in the second direction while the left-eye image for the front-side user is visible to the right eye of the user positioned at the side in the second direction.

6. The stereoscopic display according to claim 5, wherein the vision controller comprises:
a signal generating unit that generates the first control signal for closing only the left-eye shutter at a time when the right-eye image for the front-side user is displayed and closing only the right-eye shutter at a time when the left-eye image for the front-side user is displayed generates the third control signal for opening both the right-eye shatter and the left-eye shutter both at the time when the right-eye image for the front-side user is displayed and at the time, when the left-eye image for the front-side user is displayed and generates the second control signal for closing only the right-eye shutter at the time when the right-eye image for the front-side user is displayed and for closing only the left-eye shutter at the time when the left-eye image for the front-side user is displayed; and
a signal output unit that transmits the first control signal through the first infrared ray, transmits the third control signal through the third infrared ray and transmits the second control signal through the second infrared ray.

7. (canceled)

8. (canceled)

9. Stereoscopic glasses used for seeing a right-eye image and a left-eye image with binocular parallax alternately displayed by a stereoscopic display to allow a user to see a stereoscopic image, the stereoscopic glasses comprising:
a right-eye shutter that is configured to face a right eye of the user;
a left-eye shutter that is configured to face a left eye of the user; and
a shutter controller that is configured to receive a control signal including a first control signal, a second control signal and a third control signal to control the right-eye shutter and the left-eye shutter in accordance with the control signal, wherein
the shutter controller is configured to: close only the right-eye shutter at a first predetermined timing upon receipt of the first control signal for closing only the right-eye shutter at the first predetermined timing; close only the left-eye shutter at a second predetermined timing upon receipt of the second control signal for closing only the left-eye shutter at the second predetermined timing; and when both the first control signal for closing only the right-eye shutter and the second control signal for closing only the left-eye shutter are not received or when the third control signal for opening; both the left-eye shutter and the left-eye shutter is received open both the right-eye shutter and the left-eye shutter.
